(19) United States
(12) Patent Application Publication
(10) Pub. No.: US 2013/0054219 A1
(43) Pub. Date: Feb. 28, 2013

(54) Equivalent Electrical Model of SOI FET of Body Leading-Out Structure, and Modeling Method Thereof

(71) Applicants: Jing Chen, Shanghai (CN); Qingqing Wu, Shanghai (CN); Jiexin Luo, Shanghai (CN); Zhan Chai, Shanghai (CN); Xi Wang, Shanghai (CN)

(72) Inventors: Jing Chen, Shanghai (CN); Qingqing Wu, Shanghai (CN); Jiexin Luo, Shanghai (CN); Zhan Chai, Shanghai (CN); Xi Wang, Shanghai (CN)

(73) Assignee: SHANGHAI INSTITUTE OF MICROSYSTEM AND INFORMATION TECHNOLOOGY, CHINESE ACADEMY, Shanghai (CN)

(21) Appl. No.: 13/696,416

(22) PCT Filed: Sep. 25, 2011
(86) PCT No.: PCT/CN11/80143

§ 371 Date: Nov. 6, 2012

(30) Foreign Application Priority Data
Mar. 24, 2011 (CN) 201110072207.6

(51) Int. Cl. G06G 7/62

(52) U.S. Cl. 703/14

(57) ABSTRACT

The present invention provides an equivalent electrical model of a Silicon On Insulator (SOI) Field Effect Transistor (FET) of a body leading-out structure, and a modeling method thereof. The equivalent electrical model is formed by an internal FET and an external FET connected in parallel, where the SOI FET of a body leading-out structure is divided into a body leading-out part and a main body part, the internal FET represents a parasitic transistor of the body leading-out part, and the external FET represents a normal transistor of the main body part. The equivalent electrical model provided in the present invention completely includes the influence of parts of a physical structure of the SOIMOSFET device of a body leading-out structure, that is, the body leading-out part and the main body part, on the electrical properties, thereby improving a fitting effect of the model on the electrical properties of the device.

### BACKGROUND OF THE PRESENT INVENTION

1. Field of Invention

The present invention relates to an equivalent electrical model of a Field Effect Transistor (FET) and a modeling method thereof, and particularly to an equivalent electrical model of an Silicon On Insulator (SOI) FET of a body leading-out structure and a modeling method thereof, belonging to the field of micro-electronic device modeling.

2. Description of Related Arts

A Metal Oxide Semiconductor Field Effect Transistor (MOSFET) is a four-port semiconductor device, the drain current changes accordingly where different excitation is applied to each port. An input/output mathematical expression is obtained by establishing a mathematical model of the device, and circuit designers use the model to perform Simulation Program with Integrated Circuit Emphasis (SPICE emulation) during circuit design.

An SOI FET (also referred to as MOSFET) generally has two application patterns. In one application pattern, a body leading-out structure (including T-shaped gate leading-out structure and an H-shaped gate leading-out structure) exists, and in the other application pattern, no body leading-out structure exists (that is, a floating structure). FIG. 1 is a schematic diagram of the layout of a device containing a T-shaped gate leading-out structure. When a voltage is applied to the gate, the substrate under the T-shaped gate 102 is reversed to form a conductive channel. Currently, it is generally considered that the properties of the channel are completely consistent with those of the channel under a normal gate 101. Therefore, the effective width of the device could increase because of the T-shaped gate 102. However, such a processing manner is extremely simple, and is even faulty in the current process. The device may even present some characteristics that a SPICE model fails to cover.

The T-shaped gate 102 is not singly doped, where one half is doped with N-type impurities and the other half is doped with P-type impurities. The electrical properties of the T-shaped gate 102 are totally different from those of the singly doped normal gate 101. Based on the above, the present invention provides an equivalent electrical model of an SOI FET of a body leading-out structure, so as to more accurately and effectively model and emulate the SOI FET.

### SUMMARY OF THE PRESENT INVENTION

The technical problem to be solved by the present invention is to provide an equivalent electrical model of an SOI FET of a body leading-out structure, and a modeling method thereof.

In order to solve the foregoing technical problem, the present invention adopts the following technical solutions.

The present invention provides an equivalent electrical model of an SOI FET of a body leading-out structure, which is formed by an internal FET and an external FET connected in parallel. The SOI FET of a body leading-out structure is divided into a body leading-out part and a main body part, wherein the internal FET represents a parasitic transistor of the body leading-out part, and the external FET represents a normal transistor of the main body part.

As a preferred solution of the present invention, the internal FET and the external FET share four ends: a gate, a source, a drain, and a body.

As a preferred solution of the present invention, the internal FET and the external FET have different model parameters.

A modeling method of the equivalent electrical model of an SOI FET of a body leading-out structure comprises:

first, fabricating a device of a body leading-out structure and an auxiliary device only comprising a body leading-out part in the device of a body leading-out structure respectively;

then, performing an electrical test on the device of a body leading-out structure and the auxiliary device respectively;

using test data of the auxiliary device to extract relevant parameters of an internal FET in the model, for representing a parasitic transistor of the body leading-out part; and

extracting, through intermediate data, relevant parameters of an external FET representing a normal transistor, wherein the intermediate data is obtained by subtracting the test data of the auxiliary devices from test data of all devices of a body leading-out structure in the same test conditions.

The beneficial effects of the present invention are as follows:

The equivalent electrical model provided in the present invention completely includes the influence of parts (that is, the body leading-out part and the main body part) of a physical structure of the SOIMOSFET device of a body leading-out structure on the electrical properties, thereby improving a fitting effect of the model on the electrical properties of the device. An accurate SOIMOSFET device model facilitates the emulation of SOI circuit design, which is significant for the development of the SOI circuit.

### BRIEF DESCRIPTION OF THE DRAWINGS

FIG. 1 is a schematic diagram of an SOI FET of a T-shaped gate leading-out structure according to an embodiment.

FIG. 2 is a schematic diagram of a main body part of an SOI FET of a body leading-out structure according to an embodiment.

FIG. 3 is a schematic diagram of an SPICE symbol of an electrical model of an SOI FET of a body leading-out structure according to an embodiment.

FIG. 4 is a schematic diagram of a leading-out part of an SOI FET of a body leading-out structure according to an embodiment.

FIG. 5 is a schematic diagram of test data of an SOI FET of a body leading-out structure according to an embodiment.

### DETAILED DESCRIPTION OF THE PREFERRED EMBODIMENTS

A device structure consistent with the present invention is further described in the following with reference to the accompanying drawings, and the accompanying drawings are not drawn to scale for ease of showing.

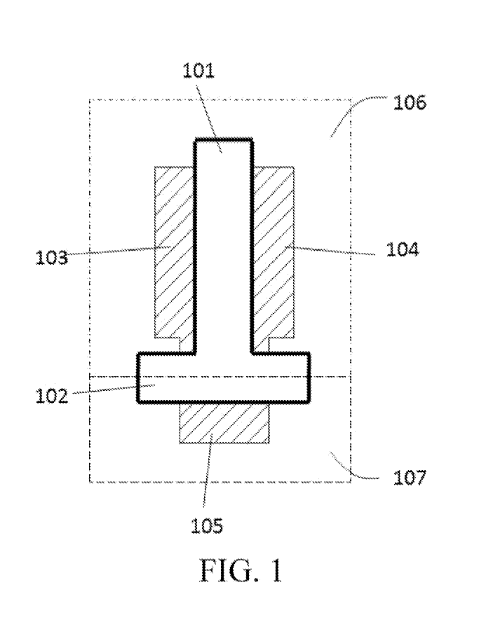

By testing and researching an SOI FET of a body leading-out structure, the inventor of the present invention finds that, in an SOI FET of a T-shaped leading-out structure, as shown in FIG. 1, a substrate below a T-shaped gate 102 of a body leading-out part is also reversed to form a conductive channel, and properties of the channel are inconsistent with those of a channel below a normal gate 101 of a main body part. The T-shaped gate 102 is not singly doped, where one half is doped with N-type impurities and the other half is doped with P-type impurities. The electrical properties of the T-shaped gate 102 are totally different from those of the singly doped normal gate 101. Currently, during emulation modeling, generally, the T-shaped gate 102 is only equivalent to that an effective width of the device is increased. It can be seen that, an electrical model established in this manner is inaccurate, and an actual device may present some properties that an existing SPICE model fails to cover.

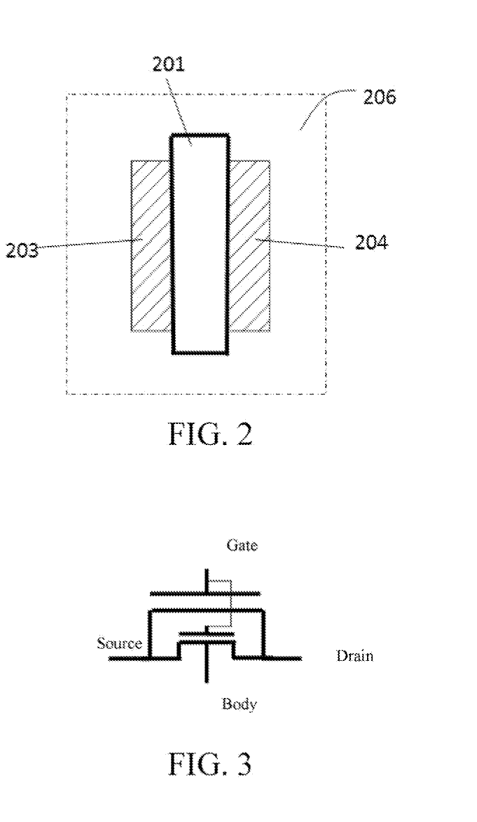

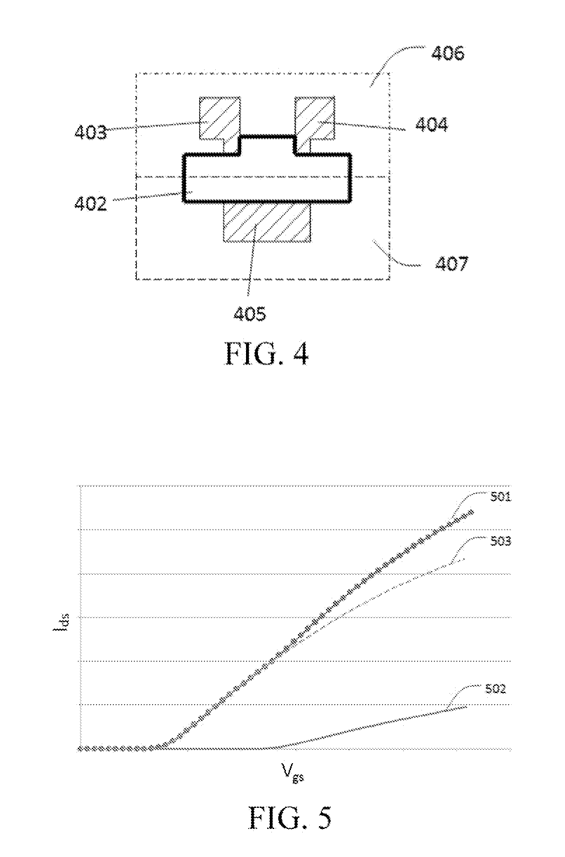

Based on the foregoing analysis and research, the inventor of the present invention improves an existing electrical model of the SOI FET of a body leading-out structure. The SOI FET of a body leading-out structure is divided into a main body part and a body leading-out part, as shown in FIG. 2 and FIG. 4, where the difference between a parasitic transistor of the body leading-out part (that is, the part of the T-shaped gate 102) and a normal transistor of the main body part is fully considered, so as to establish a new electrical model. An SPICE symbol of the electrical model is shown in FIG. 3. The electrical model is formed by an internal FET and an external FET connected in parallel, where the internal FET represents a parasitic transistor of the body leading-out part (below the T-shaped gate 102), the external FET represents a normal transistor of the main body part (below the normal gate 101), and the two transistors share four ends: a gate, a source, a drain, and a body, but have different model parameters. During circuit emulation, respective SPICE model parameters are invoked.

In FIG. 1, N-type doping (an NMOS is taken as an example, the same below) of the normal gate 101, a source 102, and a drain 103 is defined by a mask 106; P-type doping of a body 104 is defined by the mask 107; and doping polarities of the T-shaped gate are defined by the mask 106 and the mask 107 together. In FIG. 2, N-type doping of a normal gate 201, a source 203, and a drain 204 is defined by a mask 206. In FIG. 4, N-type doping of a source 403 and a drain 404 is defined by a mask 406; P-type doping of a body 405 is defined by a mask 407; and doping polarities of the T-shaped gate are defined by the mask 406 and the mask 407 together. A structure shown in FIG. 4 may be used as an auxiliary device, for researching the parasitic transistor of the body leading-out part (below the T-shaped gate 102).

Respective model parameters of the external FET and the internal FET may be extracted according to the following method.

First, a device of a body leading-out structure shown in FIG. 1 and an auxiliary device of the structure shown in FIG. 4 are respectively fabricated. Then, an electrical test is performed respectively on the two device structures. Test data of the auxiliary device is used to extract relevant parameters of the internal FET in the model, for representing a parasitic transistor of the body leading-out part. Relevant parameters of an external FET representing a normal transistor are extracted through intermediate data, where the intermediate data is obtained by subtracting the test data of the auxiliary devices from test data of all devices of a body leading-out structure in the same test conditions.

As shown in FIG. 5, a curve 501 indicates test data of a device of a body leading-out structure, a curve 502 indicates test data of an auxiliary device, a curve 503 indicates intermediate data obtained by subtracting the curve 502 from the curve 501. The actually tested data curve 501 of the device of a body leading-out structure is a curve obviously not having a single slope, and if a single transistor model is used for fitting, the electrical properties of the device cannot be accurately covered. Therefore, the curve 502 and the curve 503 are divided, and fitting and analysis are more accurate by using two transistors connected in parallel.

It can be seen that, the equivalent electrical model provided in the present invention can more completely reflect the influence of parts (that is, the body leading-out part and the main body part) of a physical structure of an SOI MOSFET device of a body leading-out structure on the electrical properties, thereby improving a fitting effect of the model on the electrical properties of the device. An accurate SOI MOSFET device model facilitates the emulation of SOI circuit design, which is significant for the development of the SOI circuit.

The above embodiments merely illustrate the principle and efficacy of the present invention exemplarily, and are not intended to limit the present invention. Any person skilled in the art can make modifications to the above embodiments without departing from the spirit and scope of the present invention. Therefore, the protection scope of the present invention is listed in the claims.

What is claimed is:

1. An equivalent electrical model of a Silicon On Insulator (SOI) Field Effect Transistor (FET) of a body leading-out structure,
formed by an internal FET and an external FET connected in parallel;
wherein the SOI FET of a body leading-out structure is divided into a body leading-out part and a main body part, the internal FET represents a parasitic transistor of the body leading-out part, and the external FET represents a normal transistor of the main body part.

2. The equivalent electrical model of an SOI FET of a body leading-out structure as in claim 1, wherein the internal FET and the external FET share four ends: a gate, a source, a drain, and a body.

3. The equivalent electrical model of an SOI FET of a body leading-out structure as in claim 1, wherein the internal FET and the external FET have different model parameters.

4. A modeling method of a Silicon On Insulator (SOI) Field Effect Transistor (FET), comprising the following steps:
first, respectively fabricating a device of a body leading-out structure and an auxiliary device only comprising a body leading-out part in the device of a body leading-out structure;
then, performing an electrical test on the device of a body leading-out structure and the auxiliary device respectively;
using test data of the auxiliary device to extract relevant parameters of an internal FET in the model, for representing a parasitic transistor of the body leading-out part; and
extracting, through intermediate data, relevant parameters of an external FET representing a normal transistor, wherein the intermediate data is obtained by subtracting the test data of the auxiliary devices from test data of all devices of a body leading-out structure in the same test conditions.
